(19) United States
(12) Patent Application Publication
(10) Pub. No.: US 2007/0282646 A1
(43) Pub. Date: Dec. 6, 2007

(54) Method and apparatus for workarea separation for logistics service provider operations

(76) Inventors: Bernd Lauterbach, Walldorf (DE); Wieland Schreiner, Mutterstadt (DE); Tobias Stein, Jardlaje (DE); Dominic Poetschke, Ettlingen (DE)

Correspondence Address: RICHARD F. JAWORSKI;Cooper & Dunham LLP, 1185 Avenue of the Americas, New York, NY, 10036, US

(21) Appl. No.: 11/442,795

(22) Filed: May 30, 2006

(51) Int. Cl. G06F 17/50

(52) U.S. Cl. 705/7

(57) ABSTRACT

A logistics service provider includes at least one working workarea, the at least one working workarea used for at least one of logistics planning, logistics execution, handling transactional data and handling global master data, at least one template workarea, the at least one template workarea used for at least one of generating templates for performing various operations and storing the generated templates and at least one customer workarea, the at least one customer workarea storing at least one of customer specific master data and customer specific configuration information. At least one of the logistics planning and logistics execution is performed for a customer in the working workarea, using at least one of the customer specific master data and the customer specific configuration information retrieved from that customer's at least one customer workarea.

### BACKGROUND

1. Technical Field

The present disclosure relates generally to logistics service provider operations and, more particularly, to a method and apparatus for workarea separation for logistics service provider operations.

2. Description of the Related Art

Businesses today are often faced with complex business strategies and processes. A Logistics Service Provider (LSP) can often provide processes and planning that can save a business much time and money. For example, LSPs can handle transport management and warehousing operations for general customers. LSPs can perform completely separate operations for different customers or groups of customers. LSPs can also perform separate operations for different modes and/or branches of a business. For example, inbound logistics is a major business process in transportation planning. One key challenge is to plan inbound logistics together with outbound transportation volumes to increase consolidation whenever possible.

FIG. 2 is a scenario map that shows a process of planning and executing inbound/outbound transportation based on purchase orders between a manufacturer 10 and a supplier 12 using transportation service provider 14. The process begins when a purchase order to a supplier 12 is created and entered by the manufacturer 10 (Step S2). The order is confirmed by the supplier 12 (Step S4) and transportation planning begins (Step S6). A transportation service provider 14 is selected (Step S8) and shipment is tendered and an Event Manager is initiated to track the tendering process (Step S10). The transportation service provider 14 then responds to the tender (Step S12) so that when a shipment (inbound shipment) is delivered to the supplier 12 (Step S14), the purchase order goods for the manufacturer 10 can be picked up (outbound shipment) and delivered (Step S16). After receipt of the goods (Step S18), and proof of delivery (Step S20), self billing to the transportation service provider 14 (Step S22) is performed and invoice verification and payment to the supplier 12 is carried out (Step S24).

An LSP operated on behalf of their customers can perform services to make these operations perform more efficiently so that each step is performed seamlessly and with minimum burden to the customer.

However, in order to isolate each customer's information, early LSPs often used separate hardware systems for each customer. These early LSPs were thus expensive to set up, maintain and operate.

It would be beneficial to provide an LSP system capable of managing a plurality of customers using minimal hardware overhead, while still maintaining isolation of each customer's information and yet allowing the LSP to utilize information from a plurality of customers as necessary.

### SUMMARY

This application describes tools (in the form of methodologies, apparatuses, and systems) for curriculum exclusive booking. The tools may be embodied in one or more computer programs stored on a computer readable medium or program storage device and/or transmitted in the form of a computer data signal in one or more segments via a computer network or other transmission medium.

A logistics service provider comprises at least one working workarea, the at least one working workarea used for at least one of logistics planning, logistics execution, handling transactional data and handling global master data, at least one template workarea, the at least one template workarea used for at least one of generating templates for performing various operations and storing the generated templates and at least one customer workarea, the at least one customer workarea storing at least one of customer specific master data and customer specific configuration information. At least one of the logistics planning and logistics execution is performed for a customer in the working workarea, using at least one of the customer specific master data and the customer specific configuration information retrieved from that customer's at least one customer workarea.

A computer recording medium including computer executable code for providing logistics services comprises code for providing at least one working workarea, the at least one working workarea used for at least one of logistics planning, logistics execution, handling transactional data and handling global master data, code for providing at least one template workarea, the at least one template workarea used for at least one of generating templates for performing various operations and storing the generated templates and code for providing at least one customer workarea, the at least one customer workarea storing at least one of customer specific master data and customer specific configuration information. At least one of the logistics planning and logistics execution is performed for a customer in the working workarea, using at least one of the customer specific master data and the customer specific configuration information retrieved from that customer's at least one customer workarea.

A programmed computer apparatus for providing logistics services comprises at least one working workarea, the at least one working workarea used for at least one of logistics planning, logistics execution, transactional data handling and global master data handling, at least one template workarea, the at least one template workarea used for at least one of generating templates for performing various operations and storing the generated templates and at least one customer workarea, the at least one customer workarea storing at least one of customer specific master data and customer specific configuration information. At least one of the logistics planning and logistics execution is performed for a customer in the working workarea, using at least one of the customer specific master data and the customer specific configuration information retrieved from that customer's at least one customer workarea.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows a block diagram of an exemplary computer system capable of implementing embodiments of the present disclosure;

FIG. 2 shows a diagram for describing an example of a service provided by a logistics service provider;

FIG. 3 shows a diagram for describing a logistics service provider according to embodiments of the present disclosure;

FIGS. 4A and 4B are a diagram and flowchart, respectively, for describing an operation performed by a logistics service provider according to embodiments of the present disclosure; and

FIGS. 5A and 5B are a diagram and flowchart, respectively, for describing operation of a logistics service provider according to embodiments of the present disclosure.

### DETAILED DESCRIPTION

The following exemplary embodiments are set forth to aid in an understanding of the subject matter of this disclosure, but are not intended, and may not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

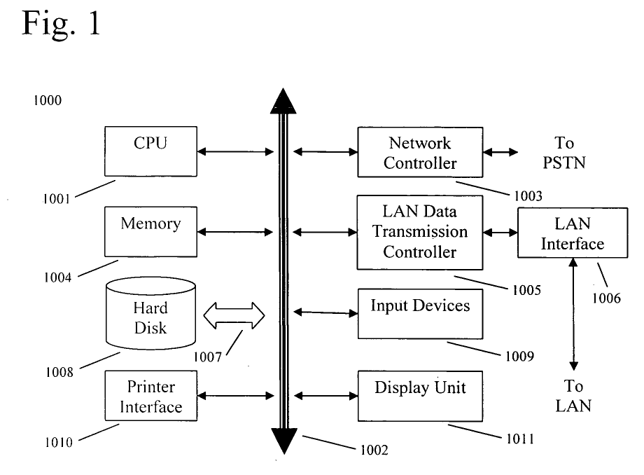

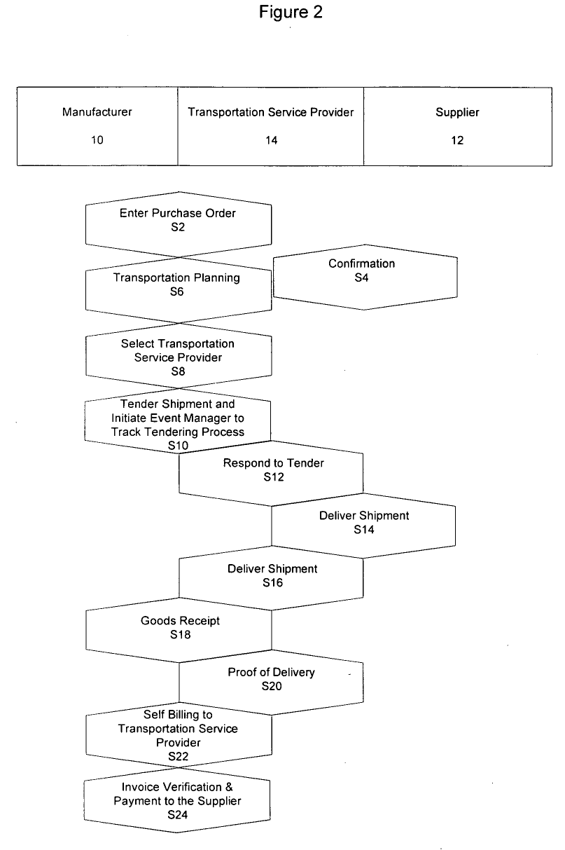

FIG. 1 shows an example of a computer system 1000 which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet.

The computer system 1000 can include a central processing unit (CPU) 1001, program and data storage devices 1004, a printer interface 1010, a display unit 1011, a (LAN) local area network data transmission controller 1005, a LAN interface 1006, a network controller 1003, an internal bus 1002, and one or more input devices 1009 (for example, a keyboard, mouse etc.). As shown, the system 1000 may be connected to a database 1008, via a link 1007.

The computer system 1000 is merely exemplary. The specific embodiments described herein are illustrative, computer system(s) as referred to herein may include(s) individual computers, servers, computing resources, networks, etc., and many variations can be introduced on these embodiments without departing from the spirit of the disclosure or from the scope of the appended claims.

As described above, an LSP can perform transportation management and warehousing operations for general customers and can perform completely separate operations for different customers or groups of customers. In fact, an LSP can perform completely separate operations for different modes and/or branches of the same customer. However, to provide the most efficient and cost effective operations possible, an LSP should be able to combine operations from different modes and/or branches of a customer and/or customers into common process steps to leverage the effective and efficient use of supplies and services. For example, an LSP capable of coordinating a combination of shipments from different branches of the same company can more efficiently control the costs for haulage and/or ocean shipment for its customer.

Embodiments of the present disclosure use “workareas” to perform operations at the LSP. A workarea is a separate data storage and processing area in an LSP's system and business. A workarea can contain data, customizing information, process configuration information, etc. Depending on the type of workarea, the data and information may be global and/or customer specific. Although maintained as separate storage and processing areas, the entities of one workarea are combinable with those of another workarea. In addition, a user can span business processes over workarea boundaries.

LSP operations require certain system features. For the various customers or groups of customers, overlaps and duplicates of identifiers, number ranges or object names may occur. For example, different customers may use the same product IDs or names for different products, the same names for different locations, etc. Accordingly, workareas of customers and/or groups of customers should be maintained strictly separate. That is, customer specific master data, customizing information, process definitions, etc. should be maintained in a separate workarea for each customer. On the other hand, the LSP should have easy access to common information where possible. Examples of such common information include geography, metrics, conversions, etc. The LSP should also be capable of utilizing global data which is assigned and/or otherwise available for all customers.

According to various embodiments of the present disclosure, authorization levels can be assigned to LSP employees, LSP customers and customers' customers granting/denying access to the data and information in each workarea as appropriate. At the same time, these embodiments allow easy switching between workareas for an LSP employee so that the LSP employee is able to work for multiple customers at the same time.

According to an embodiment of the present disclosure, to minimize hardware resources, each workarea is viewed as a separate system which is sitting on the same LSP hardware system. As separate systems can communicate with each other and as business processes can be spanned over separate systems, they can also be spanned over separate workareas. Each workarea can host operational data of a customer as well as customizing and master data for that customer. The LSP can perform processes using data and configuration information from a workarea of a first customer and/or data and configuration information from the workareas of one or more additional customers.

Direct inter-workarea data transfer via inter-workarea DB statements (e.g., SELECT . . . WORKAREA SPECIFIED . . . ) is not used. Instead, data is transferred between workareas via a Remote Function Call (RFC). Functions are performed in each workarea using program modules referred to herein as function modules. The function modules in each workarea are executed using Call Functions which execute the function modules in the same workarea. An RFC is a call of a function module that runs in a different workarea to the calling program. When an RFC is made, an RFC interface performs several operations including converting all parameter data to a representation needed in the different workarea (e.g., character string conversions, hardware-dependent conversions if needed, etc.) The RFC interface also calls any communication routines that may be used to talk to the different workarea and handles communication errors, etc. This system ensures that each of the workareas remains functionally isolated from each other.

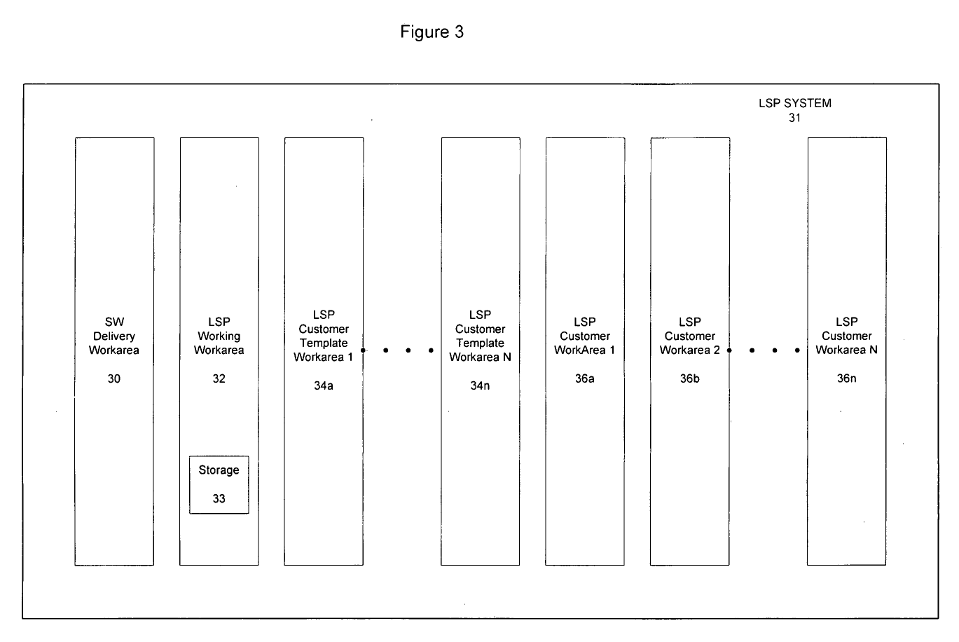

FIG. 3 shows a multi-client system utilization by LSPs. Software delivery workarea 30 is used to distribute software to appropriate parties. This can include, for example, installing new applications, patches and system software on a customer's system(s). Software delivery can be either push or pull, depending on the nature of the change. For example, a software patch may be automatically pushed to a customer's system and executed to fix a software flaw on the customer's system. The customer may download or pull a new software product as desired. LSP workarea 32 is a workarea for the entire LSP 31. LSP workarea 32 is used by the LSP for logistics planning and execution and includes storage area 33 for storing and handling transactional data and global master data. Workarea 32 is also responsible for global customizing and is used by the LSP to assign customers to a workarea. According to this embodiment of the present disclosure, ninety seven (97) LSP customer template workareas (34a-34N) are provided. The template workareas are utilized for generating and storing templates that can be transferred to an LSP customer workarea and used for performing various LSP operations. For example, template workareas include preconfigured business models and industry specific templates for new customers of industry sectors. They also include mode/branch specific templates and industry/mode specific general master data and customizing information. According to this embodiment of the present disclosure, there are also 900 LSP customer workareas (36a-36N). As the name implies, the customer workareas are used to store and handle customer specific LSP data, templates, etc. For example, the customer workareas handle customer specific master data and customer specific configuration information. A customer workarea may also maintain lists and/or descriptions of a customer's products, store and/or warehouse locations, etc. Any customer partners that use the same ID (e.g., product ID) and/or same number ranges as the customer may also have their master data and configuration information stored in the customer's workarea. Customer partners that use different ID and/or different number ranges as the customer will generally have their master data and configuration information stored in their own customer workarea if they are a client of the LSP. Industry/mode specific general master data and customizing information for the type of business the customer is engaged in may also be stored in the customer workarea.

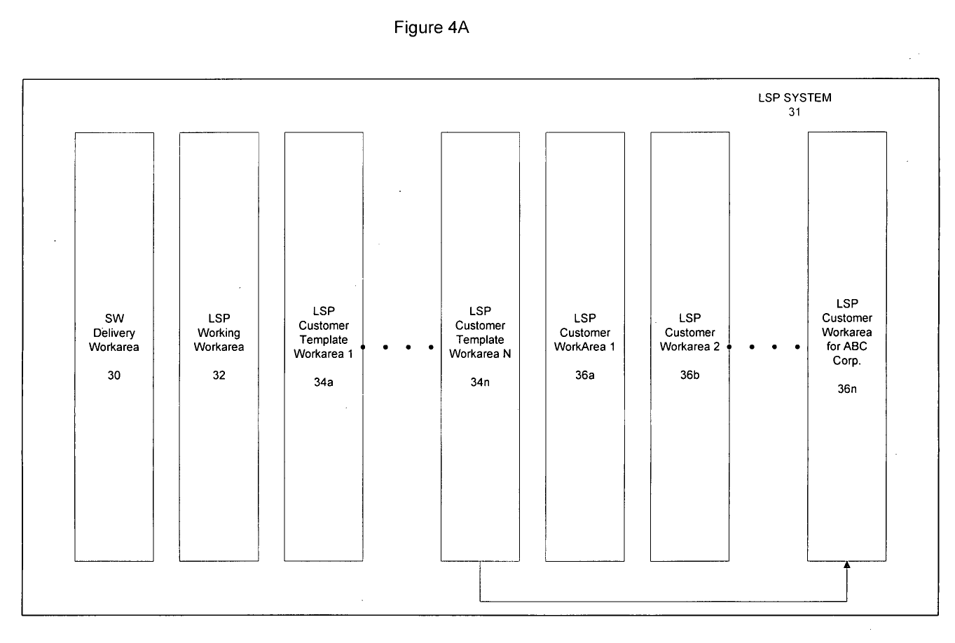

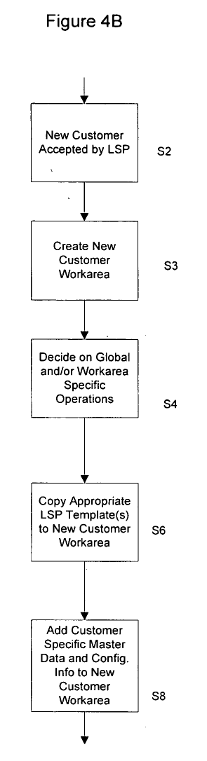

FIGS. 4A and 4B show a sales cycle of a LSP event such as the addition of a new LSP customer. In this example, a customer (ABC Corp.) has signed up to utilize services provided by LSP 40. When the customer is accepted by the LSP (FIG. 4B, Step S2), a new LSP customer workarea (ABC Corp.) is created (workarea 36n) (Step S3). LSP representatives and customer representatives sit down to discuss what services the customer would like LSP 31 to provide and what goals the customer would like to achieve. Using this information, both sides can decide on global and/or work area specific operations to be performed by LSP 31 for the customer (Step S4). The LSP can then determine appropriate customer templates for the customer and copy them from its store of customer templates in customer template workareas 34a-34n to the new customer workarea 36n (Step S6). The LSP can also then add customer specific master data and configuration information to the customer workarea 36n by manual input, data delivery or otherwise entering the data and information provided by the customer into the customer workarea (Step S8). The LSP 31 is now ready to provide services to the customer.

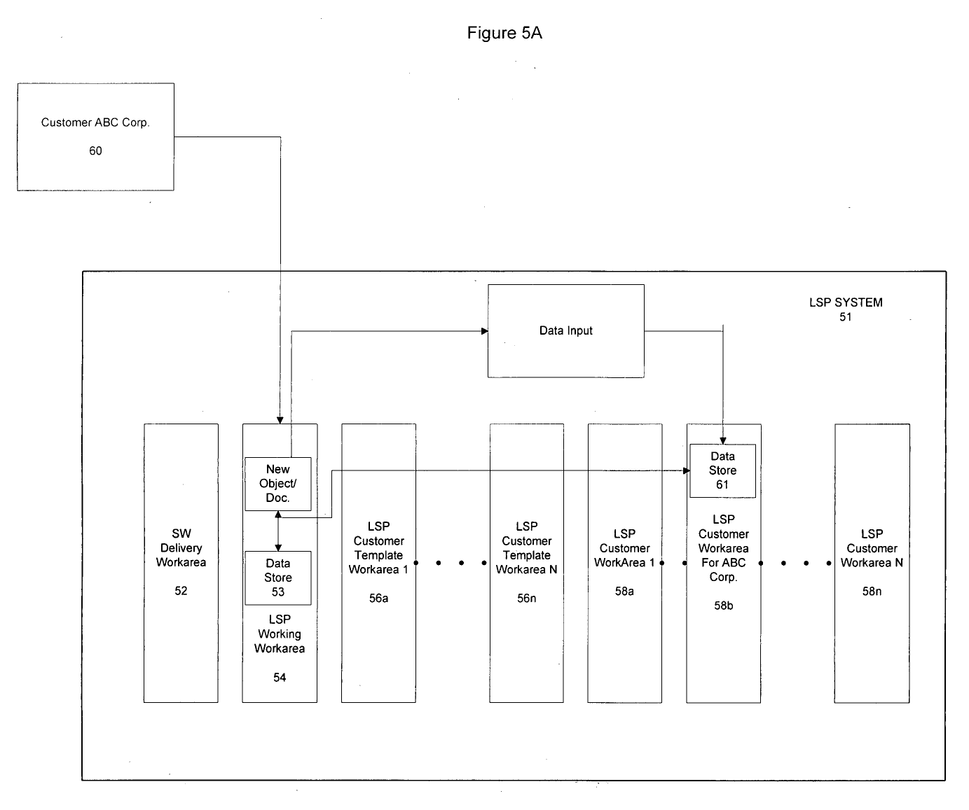

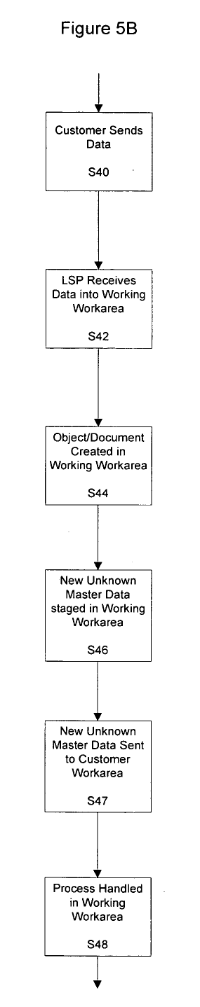

FIGS. 5A and 5B are for describing the data processing principles associated with performing work for an LSP customer. A customer 60 initiates an LSP process by sending data or calling into the LSP 51 (Step S40). The data arrives at the LSP 51 and is loaded into a working workarea (e.g., workarea 54) (Step S42). A new object/document is then created in the workarea 54 as appropriate (Step S44). Any new unknown customer specific master data and/or customer specific configuration information input by the customer 60 is staged in the working workarea 54 (Step S46) and then transferred to the customer workarea 58B using a remote function call (RFC) (Step S47). The process to be performed by the LSP is then handled in the working workarea 54 (Step S48). The process accesses any additional customer specific master data and/or customer specific configuration information used by the process, from a data store 61 in the customer workarea 58B via a RFC. Any global master data and/or global configuration information needed by the process is accessed directly from data store 53 in the working workarea 54 using a Function Call (Step S60).

The present system can be implemented in digital electronic circuitry, or in computer hardware, firmware, software, or in combinations of them. The system can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with the present system can be performed by one or more programmable processors executing a computer program to perform functions of the invention by operating on input data and generating output. Method steps can also be performed by, and apparatus of the disclosure can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROMs (Compact Disc Read-only Memory) and DVD-ROMs (Digital Versatile Disc Read-only Memory). The processor and the memory can be supplemented by, or incorporated in special purpose logic circuitry.

To provide for interaction with a user, the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The present system can be implemented in a computing system that includes a back-end component, e.g., as a data server, or that includes a middle-ware component, e.g., an application server, or that includes a front-end component, e.g., a client computer having a graphical interface or a Web browser through which a user can interact with an implementation of the present disclosure, or any combination of such back-end, middleware, or front-end components. The components of the computing system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on respective computers and having a client-server relationship to each other.

The present system has been described in terms of particular embodiments. Other embodiments are within the scope of the following claims. For example, although the present system has been described as a component in a larger system, it can also be implemented in other systems or as a stand-alone system.

Numerous additional modifications and variations of the present disclosure are possible in view of the above-teachings. It is therefore to be understood that within the scope of the appended claims, the present disclosure may be practiced other than as specifically described herein. For example, elements and/or features of different illustrative embodiments may be combined with each other and/or substituted for each other within the scope of this disclosure and appended claims.

What is claimed is:

1. A logistics service provider, comprising:
at least one working workarea, the at least one working workarea used for at least one of logistics planning, logistics execution, handling transactional data and handling global master data;
at least one template workarea, the at least one template workarea used for at least one of generating templates for performing various operations and storing the generated templates; and
at least one customer workarea, the at least one customer workarea storing at least one of customer specific master data and customer specific configuration information,
wherein at least one of the logistics planning and logistics execution is performed for a customer in the working workarea, using at least one of the customer specific master data and the customer specific configuration information retrieved from that customer's at least one customer workarea.

2. The logistics service provider of claim 1, wherein the generated templates comprise at least one of preconfigured business models and industry specific templates.

3. The logistics service provider of claim 1, further comprising a software delivery workarea for providing at least one of software and software updates to customers.

4. The logistics service provider of claim 1, wherein the at least one of the customer specific master data and the customer specific configuration information is retrieved from that customer's at least one customer workarea using a remote function call.

5. The logistics service provider of claim 1, wherein each workarea comprises a separate data storage and processing area provided on a same hardware system.

6. The logistics service provider of claim 1, wherein each customer workarea comprises at least one of lists of a customer's products, descriptions of the customer's products, lists of the customer's store locations and lists of the customer's warehouse locations.

7. A computer recording medium including computer executable code for providing logistics services, comprising:
code for providing at least one working workarea, the at least one working workarea used for at least one of logistics planning, logistics execution, handling transactional data and handling global master data;
code for providing at least one template workarea, the at least one template workarea used for at least one of generating templates for performing various operations and storing the generated templates; and
code for providing at least one customer workarea, the at least one customer workarea storing at least one of customer specific master data and customer specific configuration information,
wherein at least one of the logistics planning and logistics execution is performed for a customer in the working workarea, using at least one of the customer specific master data and the customer specific configuration information retrieved from that customer's at least one customer workarea.

8. The computer recording medium of claim 7, wherein the generated templates comprise at least one of preconfigured business models and industry specific templates.

9. The computer recording medium of claim 7, further comprising code for providing a software delivery workarea for providing at least one of software and software updates to customers.

10. The computer recoding medium of claim 7, wherein the at least one of the customer specific master data and the customer specific configuration information is retrieved from that customer's at least one customer workarea using a remote function call.

11. The computer recording medium of claim 7, wherein each workarea comprises a separate data storage and processing area provided on a same hardware system.

12. The computer recording medium of claim 7, wherein each customer workarea comprises at least one of lists of a customer's products, descriptions of the customer's products, lists of the customer's store locations and lists of the customer's warehouse locations.

13. A programmed computer apparatus for providing logistics services, comprising:
at least one working workarea, the at least one working workarea used for at least one of logistics planning, logistics execution, transactional data handling and global master data handling;
at least one template workarea, the at least one template workarea used for at least one of generating templates for performing various operations and storing the generated templates; and
at least one customer workarea, the at least one customer workarea storing at least one of customer specific master data and customer specific configuration information,
wherein at least one of the logistics planning and logistics execution is performed for a customer in the working workarea, using at least one of the customer specific master data and the customer specific configuration information retrieved from that customer's at least one customer workarea.

14. The programmed computer apparatus of claim 13, wherein the generated templates comprise at least one of preconfigured business models and industry specific templates.

15. The programmed computer apparatus of claim 13, further comprising code for providing a software delivery workarea for providing at least one of software and software updates to customers.

16. The programmed computer apparatus of claim 13, wherein the at least one of the customer specific master data and the customer specific configuration information is retrieved from that customer's at least one customer workarea using a remote function call.

17. The programmed computer apparatus of claim 13, wherein each workarea comprises a separate data storage and processing area provided on a same hardware system.

18. The programmed computer apparatus of claim 13, wherein each customer workarea comprises at least one of lists of a customer's products, descriptions of the customer's products, lists of the customer's store locations and lists of the customer's warehouse locations.
